(19) United States
(12) Patent Application Publication
(10) Pub. No.: US 2025/0187155 A1
(43) Pub. Date: Jun. 12, 2025

(54) PINCER TOOL WITH ASYMMETRICAL WEDGE

(71) Applicant: Oetiker Schweiz AG, Horgen (CH)

(72) Inventors: Corina HELLER, Horgen (CH); Gabriel SCHUSTER, Horgen (CH); Pascal MOSER, Horen (CH); Peter STEINER, Horgen (CH); Steffen RICHTER, Horgen (CH); Martin HUWYLER, Horgen (CH)

(73) Assignee: Oetiker Schweiz AG, Horgen (CH)

(21) Appl. No.: 18/844,428

(22) PCT Filed: Jul. 3, 2023
(86) PCT No.: PCT/EP2023/068252

§ 371 Date: Sep. 6, 2024

(30) Foreign Application Priority Data
Jul. 8, 2022 (DE) 10 2022 117 144.2

(51) Int. Cl. B25B 25/00

(52) U.S. Cl. CPC B25B 25/005

(57) ABSTRACT

A pincer tool (10) for tightening a band clamp. The pincer tool (10) includes a pincer head (12) including a base element (14), two jaw elements (16a, 16b) pivotably attached to the base element (14), wherein the jaw elements (16a, 16b) each include a jaw end (20a, 20b) and a rear end (22a, 22b) on opposite sides of the pivot point, and a wedge element (26) mounted on the base element (14) to be movable in a longitudinal direction (D) by pressure of a pressurizing agent, wherein the wedge element (26) is configured to separate the rear ends (22a, 22b) of the jaw elements (16a, 16b) when being pressed in the longitudinal direction (D) so as to move each of the jaw ends (20a, 20b) by a stroke.

The invention relates to a pincer tool is configured for tightening a band clamp.

In particular, the invention relates to a pincer tool for closing a band clamp with overlapping inner- and outer band portions which are moved relative to one another when the band clamp is being closed. This includes but is not limited to low-profile clamps with engagement hooks for engaging the jaws of the pincer tool, in particular to low-profile clamps with tolerance compensation structures. Moreover, the invention can be applied to pincer tools for called stepless ear clamp assembly tools.

The document WO 200196071 A1 discloses a pincer tool according to the preamble of claim 1.

Known pincer tools operate in a symmetric way, i.e. the strokes of the two jaws are symmetric to a longitudinal axis of the tool body. However, upon closing the clamp, the friction experienced by the inner and outer band portions are different. If the pincer tool is mounted on a fixed support, e.g. in in fully automated assembly sites, this results in different forces exerted by the jaws and, consequently, an angular momentum acting on both the tool and the clamp may lead to torsional deformations of the hose or tube to be clamped, bunching and/or wear. The asymmetry in the clamping forces corresponds to a concentration of the clamping force onto one of the sides, which may result in a breaking of one of the clamping structures.

This problem is less pronounced if the pincer tool is a hand-held tool because the user will unconsciously follow the natural movement of the clamping structures (ear or hooks), wherein the natural movement is the movement of the band ends caused by exerting identical pressure on both jaws, i.e. where the band end with lower friction (usually the outer band end) moves while the other band end remains at its place. In low-profile clamps having tolerance compensation structures, the side with the tolerance compensation structure is more likely to move.

It is known to mount pincer tools on a movable sled such that the pincer tool can follow the natural movement of the clamping structures (ear or hooks), thereby mimicking the reaction of a huma. However, this setup requires additional components and complicated adjustment.

The invention is based on the problem of improving pincer tool so as to avoid breaking of a clamping structure, torsional forces and deformations.

The problem is solved by a device having the features of claim 1. Advantageous embodiments of the invention are defined in the dependent claims.

The invention relates to a pincer tool for tightening a band clamp. The pincer tool includes a pincer head and the pincer head includes a base element and two jaw elements. The jaw elements are pivotably attached to the base element on a pivot point, wherein the jaw elements each include a jaw end and a rear end on opposite sides of the pivot point. The pincer head further includes wedge element mounted on the base element so as to be movable in a longitudinal direction by pressure of a pressurizing agent. The wedge element is configured to separate the rear ends of the jaw elements when being pressed in the longitudinal direction so as to move each of the jaw ends by a stroke.

It is proposed that the wedge element has at least one configuration in which the strokes by which the jaw ends are moved differ from each other. The strokes can be set to correspond to the natural movement of the clamp when the latter is being closed. This prevents damages and results in an improved closure quality.

The inventors further propose that the wedge element includes wedge surfaces with different slopes. This is a simple and robust solution which can be adapted to specific use cases.

In a preferred embodiment of the invention, the wedge element includes a rear element guided in the longitudinal direction and a front part configured to be pivoted by a difference in counterforces exerted by the rear ends. The pivoting enables a flexible adaptation of the strokes to different use cases. The path jaws of the jaw element can be flexibly adapted to the circumstances.

The flexible wedge reacts in particular to the asymmetrical closure that occurs when a low-profile clamp with compensation elements is closed in a fully automated site. The fixed pincer head can't compensate the difference in force and movement occurring at the two contact points between clamp and tool (pincer jaws and hooks). The flexible wedge takes over the compensation task.

It is further proposed that the rear element and the front part include opposing abutment surfaces configured to stop the pivoting at predetermined maximum pivot angles. The abutment surfaces do not only prevent excessive pivoting but further to transmit pressure in a robust and reliable way.

In preferred embodiment, the opposing abutment surfaces are curved and preferably shaped in such a manner that a contact area between the rear element and the front part increases with increasing difference in counterforces.

The inventors further propose that the front part includes a main body and a joint head engaging in a socket structure of the rear element, wherein the joint head is connected to the main body by a neck part.

Preferably, the rear ends of the jaw elements are provided with rolls to reduce friction.

Further features and advantages will be apparent from the following description of the embodiments and figures. The entire description, claims and figures disclose features of the invention in specific embodiments and combinations. The person skilled in the art will also consider the features individually and combine them into further combinations or sub-combinations to adapt the invention, as defined in the claims, to his needs or to specific fields of application.

The figures illustrate the following:

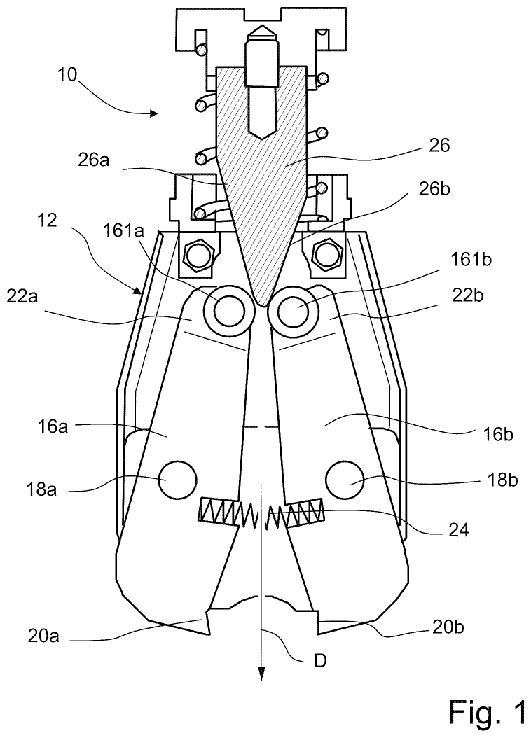

FIG. 1 illustrates a pincer tool according to a first embodiment of the invention; and

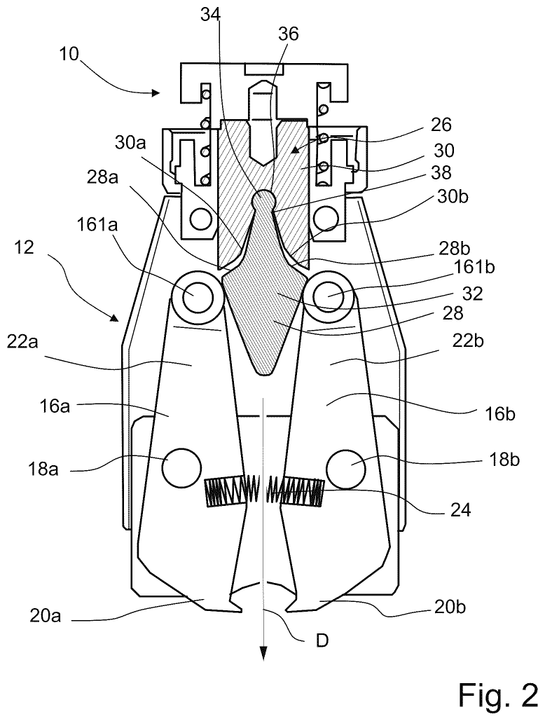

FIG. 2 illustrates a pincer tool according to a second embodiment of the invention.

FIG. 1 shows pincer tool 10 according to a first embodiment of the invention. The pincer tool 10 is configured for tightening a band clamp, in particular a band clamp with overlapping inner- and outer band portions which are moved relative to one another when the band clamp is being closed. This includes but is not limited to low-profile clamps with engagement hooks or engaging the jaws of the pincer tool 10 and so-called stepless ear clamps.

The pincer tool 10 includes a main body (not illustrated) with one or more pistons to be moved by the pressure of a pressurizing agent. The pressurizing agent may by air in the case of a pneumatic pincer tool 10 or hydraulic oil in the case of a hydraulic pincer tool 10.

A pincer head 12 is attached to a front end of the main body. The pincer head 12 includes a plate-shaped base element 14 and two jaw elements 16a, 16b pivotably attached to the base element 14 via a pivot bolt 18a, 18b on a pivot point, respectively.

The jaw elements 16a, 16b each include a jaw end 20a, 20b and a rear end 22a, 22b on opposite sides of the pivot point such that the jaw ends 20a, 20b are approached to each other when the rear ends 22a, 22b are separated and vice versa. The pivot axis of the jaw elements 16a, 16b as defined by the pivot bolts 18a, 18b is oriented in a direction perpendicular to the longitudinal direction. A spiral spring 24 is arranged between the jaw elements 16a, 16b and configured to restore the jaw elements 16a, 16b into an open configuration when no force is exerted to the rear ends 22a, 22b.

The pincer head 12 further includes a wedge element 26 mounted on the base element 14 so as to be movable in a longitudinal direction D by pneumatic pressure. The wedge element 26 is directly or indirectly connected to the foremost piston in the main body or be formed as one piece with the piston. The wedge element 26 is configured to separate the rear ends 22a, 22b of the jaw elements 16a, 16b when being pressed in the longitudinal direction D so as to move each of the jaw ends 20a, 20b by a stroke along a curved path around the pivot point, wherein the path is oriented in a direction substantially perpendicular to the longitudinal direction D and perpendicular to the pivot axis.

According to the embodiment of FIG. 1, the wedge element 26 includes wedge surfaces 26a, 26b with different slopes in relation to the longitudinal direction D. The rear ends 22a, 22b of the jaw elements 16a, 16b are provided with rolls 161a, 161b in contact with the opposing wedge surfaces 26a, 26b such that the slopes of the wedge surfaces 26a, 26b set the gear ratio of the translation of the longitudinal movement of the wedge element 26 into the transversal movement of the jaw ends 20a, 20b of the jaw elements 16a, 16b. The wedge element 26 is asymmetrical with regard to the longitudinal direction D.

As a consequence of the different slopes, the wedge element 26 has a configuration which is such that the strokes by which the jaw ends 20a, 20b are moved by a full or predetermined stroke of the wedge element 26 differ from each other.

FIG. 2 shows a second embodiment of the invention. In order to avoid repetition, the following description of the second embodiment is essentially limited to differences from the first embodiment of the invention. Because of the unchanged features, the skilled person is referred to the description of the first embodiment. The same reference signs are used for features of the second embodiment that have the same or similar effect in order to emphasize the similarities.

In the second embodiment of FIG. 2, the wedge element 26 includes a rear element 30 guided in the longitudinal direction D and a flexible, pivotable front element 28 configured to be pivoted by a difference in counterforces exerted by the rear ends 22a, 22b. In the forceless configuration of FIG. 2, the wedge surfaces 26a, 26b of the front element 28 have opposing slopes with the same absolute value in relation to the longitudinal direction D such that, in the forceless configuration, the wedge element 26 is symmetrical with regard to the longitudinal direction D.

When a difference in counterforces exerted by the rear ends 22a, 22b of the jaw elements 16a, 16b exists, the an angular momentum acts on the front element 28 and the front element 28 is pivoted around a pivot axis perpendicular to the longitudinal direction D by a certain amount.

The rear element 30 and the front element 28 include opposing abutment surfaces 30a, 30b, 28a, 28b configured to stop the pivoting at predetermined maximum pivot angles. The opposing abutment surfaces 30a, 30b, 28a, 28b are curved and shaped in such a manner that a contact area between the rear element 30 and the front element 28 increases with increasing difference in counterforces. When large forces are applied, the abutment surfaces 30a, 30b, 28a, 28b will almost inevitably be in full contact such that the pressure is transmitted via the entire abutment surfaces 30a, 30b, 28a, 28b rather than the pivot joint between the rear element 30 and the front element 28.

More specifically, the front element 28 includes a main body 32 and a joint head 34 engaging in a socket structure 36 of the rear element 30, wherein the joint head is connected to the main body by a neck part 38.

When a difference in transversal counterforces is applied to the jaw ends 20a, 20b of the jaw elements 16a, 16b, a difference proportional to the former difference exists between the forces applied by the rolls 161a, 161b onto the wedge surfaces 26a, 26b. The resultant force pivots the front element 28 into one of the two opposite directions and moves the wedge element 26 into an asymmetrical configuration in which the slopes of the wedge surfaces 26a, 26b as measured with reference to the longitudinal direction D differ from each other. This applies in particular to a configuration where two of the opposing pairs of abutment surfaces 30a, 30b, 28a, 28b are in contact. As a consequence, the wedge element 26 has a configuration which is such that the strokes by which the jaw ends 20a, 20b are moved by a full or predetermined stroke of the wedge element 26 differ from each other as in the embodiment of FIG. 1.

Tests showed a better result compared to a standard wedge. A higher closing force could be reached before hook breaking.

### LIST OF REFERENCE NUMBERS

10 pincer tool
12 pincer head
14 base element
16a, 16b jaw elements
18a, 18b pivot bolts
20a, 20b jaw ends
22a, 22b rear ends
24 spiral spring
26 wedge element
26a, 26b wedge surface
28 front element
28a, 28b abutment surfaces
30 rear element
30a, 30b abutment surfaces
32 main body
34 joint head
36 socket structure
38 neck part
161a, 161b rolls

1. A pincer tool (10) for tightening a band clamp, the pincer tool (10) including a pincer head (12), the pincer head (12) comprising:
a. a base element (14);
b. two jaw elements (16a, 16b) pivotably attached to the base element (14) on a pivot point, wherein the jaw ele-ments (16a, 16b) each include a jaw end (20a, 20b) and a rear end (22a, 22b) on opposite sides of the pivot point; and
c. a wedge element (26) mounted on the base element (14) so as to be movable in a longitudinal direction (D) by pressure of a pressurizing agent, wherein the wedge element (26) is configured to separate the rear ends (22a, 22b) of the jaw elements (16a, 16b) when being pressed in the longitudinal direction (D) so as to move each of the jaw ends (20a, 20b) by a stroke, wherein the wedge element (26) has at least one configuration in which the strokes by which the jaw ends (20a, 20b) are moved differ from each other.

2. The pincer tool (10) according to claim 1, wherein the wedge element (26) includes wedge surfaces (26a, 26b) with different slopes.

3. The pincer tool (10) according to claim 1, wherein the wedge element (26) includes a rear element (30) guided in the longitudinal direction (D) and a front element (28) configured to be pivoted by a difference in counterforces exerted by the rear ends (22a, 22b).

4. The pincer tool (10) according claim 3, wherein the rear element (30) and the front element (28) include opposing abutment surfaces (30a, 30b, 28a, 28b) configured to stop the pivoting at predetermined maximum pivot angles.

5. The pincer tool (10) according claim 4, wherein the opposing abutment surfaces (30a, 30b, 28a, 28b) are curved and shaped in such a manner that a contact area be-tween the rear element (30) and the front element (28) in-creases with increasing difference in counter-forces.

6. The pincer tool (10) according to claim 3, wherein the front element (28) includes a main body (32 and joint head (34) engaging in a socket structure (36) of the rear element (30, wherein the joint head (34) is connected to the main body by a neck part (38.

7. The pincer tool (10) according to claim 1, wherein the rear ends (22a, 22b) of the jaw elements (16a, 16b) are provided with rolls (161a, 161b).
